(19) United States
(12) Patent Application Publication
(10) Pub. No.: US 2003/0233649 A1
(43) Pub. Date: Dec. 18, 2003

(54) Maintaining software in computers in a network

(76) Inventor: Scott Reimert, San Jose, CA (US)

Correspondence Address: KAPLAN & GILMAN , L.L.P., 900NROUTE 9 NORTH, WOODBRIDGE, NJ, 07095, US

(21) Appl. No.: 10/172,414

(22) Filed: Jun. 14, 2002

(51) Int. Cl. G06F 9/445

(52) U.S. Cl. 717/176

(57) ABSTRACT

The invention disclosed herein provides an apparatus and method for maintaining current versions of software in client computers in a common network. A systems management server computer connected to the network communicates with each of the client computers in response to periodic inquiries from each client computer as to the availability of new or updated applications. The SMS determines what new and updated applications are to be installed on each client computer and sends information regarding the nature of the programs and their expected installation times.

### FIELD OF THE INVENTION

The present invention relates generally to the field of computer software management, and more particularly to a method for installing and updating computer programs on a number of computers in a network.

### BACKGROUND OF THE INVENTION

Larger companies typically have their own information technology specialist or department to provide services involving the operations, maintenance and programming of computers. Small and medium sized companies are more likely to contract with outside firms or consultants to provide similar services. These services are termed systems management services, some of which are performed through a systems management server. An existing product of this type is referred to as Microsoft SMS, although several other management server systems are available. Systems management services ordinarily include training of personnel, correction of operating problems encountered, providing and updating of the software programs that are commonly used. Multiple SMS servers may be clustered in an SMS site. In both large and small company environments, client computers are typically connected to each other and to one or more servers through a local area network (LAN), which may also connect to a wide area network (WAN).

Frequently, a new application or an update of an existing application becomes available that would be of benefit to the client computers. However, in order to ensure that all the client computers in a particular group remain operating at optimum efficiency, it is preferred to first determine whether individual clients can use or actually need those applications. To make an intelligent determination of when to install software, an SMS needs to evaluate the application with respect to various parameters of the client computer. As the invention is described below the terms “program,” “application” and “software” are interchangeable.

Therefore, it is an object of the present invention to provide means for maintaining software applications among client computers in a network.

It is a further object of the present invention to provide means to evaluate the need for new and updated software applications with respect to the individual client computers.

These and other objects will become more apparent from the description of the invention to follow.

### SUMMARY OF THE INVENTION

The invention disclosed herein provides an apparatus and method for maintaining software in client computers in a common network. An SMS computer that is connected to the network is capable of communicating with each of the client computers on the network. A source of new applications and updates to existing applications is in communication with the SMS computer. Each client computer checks regularly with the SMS to reveal if any new or updated software programs have become available for installation. When a new application or application update is published, the SMS responds to the inquiring client computer by providing corresponding information sufficient to inform the client of the available programs and their installation times.

### BRIEF DESCRIPTION OF THE DRAWINGS

FIG. 1 is a diagrammatic depiction of a local area network having a plurality of client computer terminals, a servicing computer and a source of new applications or application updates.

FIG. 2 is a flowchart showing a series of operations according to a preferred embodiment of the present invention.

### DETAILED DESCRIPTION OF THE INVENTION

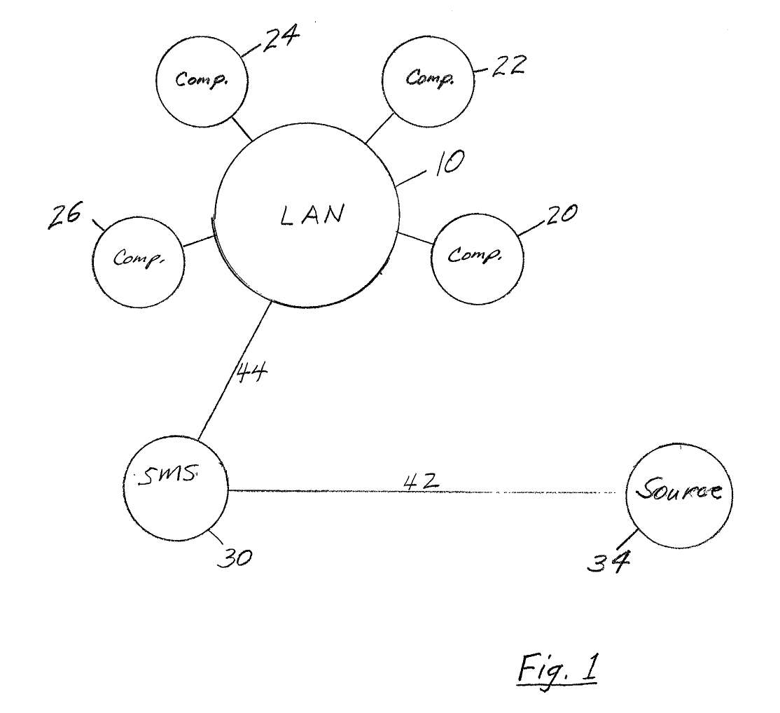

The objects set forth above are satisfied and an advance in the field of computer operations is achieved by the present invention as disclosed below. Referring now to FIG. 1, an exemplary local area network (LAN) 10 is illustrated with a plurality of client computers 20, 22, 24 and 26 connected thereto. Client computers may be personal computers (PCs) or of other types of workstations in the preferred embodiment. In addition, an SMS 30 is connected to LAN 10 for providing maintenance and other services to the client computers 20-26 that are connected to LAN 10. Connections are such that SMS 30 and client computers 20-26 communicate directly with each other. SMS 30 represents one or more servers in an SMS site.

A source of software, for example new applications and application updates, such as software source 34, is connected through a link 42 to SMS 30. Source 34 is connected so as to be able to transmit application updates and new applications through link 42 to SMS 30. It is understood that link 42 and other links described in respect to LAN 10 may be hard wire connections or virtual links. There frequently is a further connection between LAN 10 and a WAN (not shown) or a global network such as the Internet.

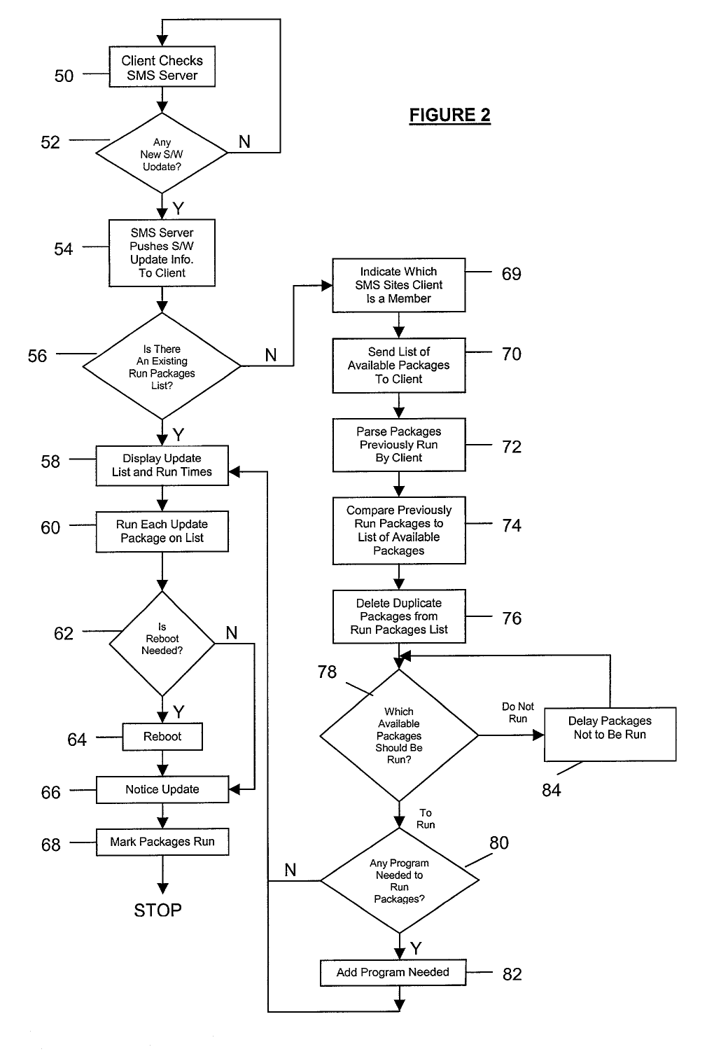

Referring now to FIG. 2, the operations of SMS 30 and of each client computer 20-26 is illustrated in the form of a flowchart. A client periodically inquires of SMS 30 at step 50 whether any new software or software update is available. According to the particular situation, such an inquiry may be made at the initiation of the operator, or automatically on a daily, hourly or at another arbitrary interval. Regardless of the user initiation, a default inquiry is programmed into each client computer, typically on the order of hourly, to ensure the regular inquiring for possible new software availability. A determination is made in step 52 whether any new or updated software application is available for installation. In very rare situations, the user is given the option to postpone or refuse an installation. If the response to the step 52 inquiry is negative, i.e. no new or update program is available and compatible for installation, the system cycles back to step 50 to await the next inquiry from the client computer. If the response is positive, SMS 30 provides information relating to available new or update applications in step 54 to the inquiring client computer. The relevant information will typically include the number of updates or new applications available for downloading and the estimated installation time for each. The client computer then checks in step 56 whether a list of previously run installation packages exists.

If the result of the inquiry at step 56 is negative, an indication is made in step 69 as to which SMS sites the client is a member. At the completion of step 69, a list of available installation packages is generated and sent to the client computer in step 70. The packages previously run by the client computer are parsed in step 72. A comparison is made in step 74 between the previously run installation packages and the list of available installation packages found. Those installation packages listed in both places, duplicated, are removed from the run installation packages list in step 76. The system next determines in step 78 which of the available installation packages should be run. Such a determination, normally made by SMS 30, is based on a number of known factors, such as (1) the space available on the client computer's hard drive, (2) whether the new program is compatible with the operating system in use on the particular client computer, (3) whether the user is logged on (may be not needed for certain installations), (4) whether the program is for maintenance (like security) or for operating, and (5) whether the new program has been authorized for installation by the program administrator. Those installation packages on the list which should not be run are recycled at step 84 to step 78 to await a future installation time. Those packages which should be promptly run are moved forward from step 78 to step 80 where it is determined whether any dependency program is needed to enable the running. If a dependency is needed, e.g. such as Acrobat® Reader, it is added in step 82 and the programs to be run are added to the programs list at step 58.

If the response to the step 56 inquiry is positive, an update program and run times list is displayed to the user of the client computer in step 58. Then, each new and update program on the list is run in step 60. In step 62, a determination is made from the run programs as to whether a reboot of the system is needed. If the response is negative, the system shunts past the reboot operation of step 64. If the response is positive, a reboot is executed at step 64. A notification of the installations and updates that have been run is generated in step 66. The notification of step 66 includes an indication as to whether the installation succeeded; failed installations are retained in the available programs list for a future rerun. Those programs that have been successfully run are marked in step 68 and removed from the availability list. Next, the process is stopped to await a further check by the client computer of the SMS.

While the present invention is described with respect to specific embodiments thereof, various modifications and variations may be possible without departing from the scope and spirit of the invention, which is more clearly and precisely defined by reference to the claims appended hereto.

What is claimed is:

1. A method for maintaining software in computers in a network, comprising the steps of:
(a) responding to a client computer inquiry as to whether at least one new or updated application is available for installation; and
(b) if new or updated applications are available, informing the client computer of the number of applications and the installation times for such applications.

2. The method for maintaining software as described in claim 1, further comprising determining the existence of a list of previously run programs.

3. The method for maintaining software as described in claim 2, further comprising listing available programs.

4. The method for maintaining software as described in claim 3, further comprising parsing previously run programs.

5. The method for maintaining software as described in claim 4, further comprising deleting previously run programs from a list of available programs.

6. The method for maintaining software as described in claim 5, further comprising determining which of the available programs should be run.

7. The method for maintaining software as described in claim 6, further comprising delaying the running of those programs that are determined to not be necessary to run promptly.

8. The method for maintaining software as described in claim 6, further comprising determining whether a dependency is needed in order to run any available program.

9. The method for maintaining software as described in claim 8, further comprising activating a pertinent dependency if it is needed.

10. The method for maintaining software as described in claim 9, further comprising installing the program or programs that are available and needed.

11. The method for maintaining software as described in claim 10, further comprising determining whether a reboot operation is needed subsequent to installing the programs.

12. The method for maintaining software as described in claim 11, further comprising rebooting if it has been determined that rebooting is needed.

13. The method for maintaining software as described in claim 11, further comprising deleting those programs from the list that have been successfully run.
